(19) United States
(12) Patent Application Publication
(10) Pub. No.: US 2008/0113308 A1
(43) Pub. Date: May 15, 2008

(54) Sectional candle apparatus

(76) Inventor: Robert Bruce Kleve, Farmington, MI (US)

Correspondence Address: ROBERT E. KLEVE, 1103-24TH AVE S., GRAND FORKS, ND, 58201, US

(21) Appl. No.: 11/595,762

(22) Filed: Nov. 10, 2006

(51) Int. Cl. C11C 5/00; F23D 3/16; F23D 21/00

(52) U.S. Cl. 431/253; 431/289

(57) ABSTRACT

The invention comprises a sectional candle apparatus. The candle is made in a plurality of sectional candle wax portions. A plurality of thin non combustable wafers separate each of the candle portions or sections from one another with openings centrally of each wafers or spacers so that one continues wick may extend through the candle portions and through the spacer. The candle can be turned by the wick down to one of the spacers and then the remaining unburned portion of one uppermost candle sectional portion broken off evenly across the spacer to provide an even top surface to the candle.

The invention relates to making candles in sections.

It is an object of the invention to provide a novel wax candle made containing non-flammable and non-wax material thin spacers which enables the owner of the candle to separate the candle in sections as the candle burns down to the spacer.

As the candle burns downwardly, in normal circumstances, the upper unburned portion of the candle will burn to a hollow recessed portion. Before the hollow recessed portion burns fully downward to the spacer, the candle may be extinguished and the hollow recessed portion may be separated cleanly at the spacer and removed along with the spacer, so that the remaining lower unburned portion of the candle will have an even uppermost surface rather than the uneven hollowed out surface so as to once again resemble a new shorter candle.

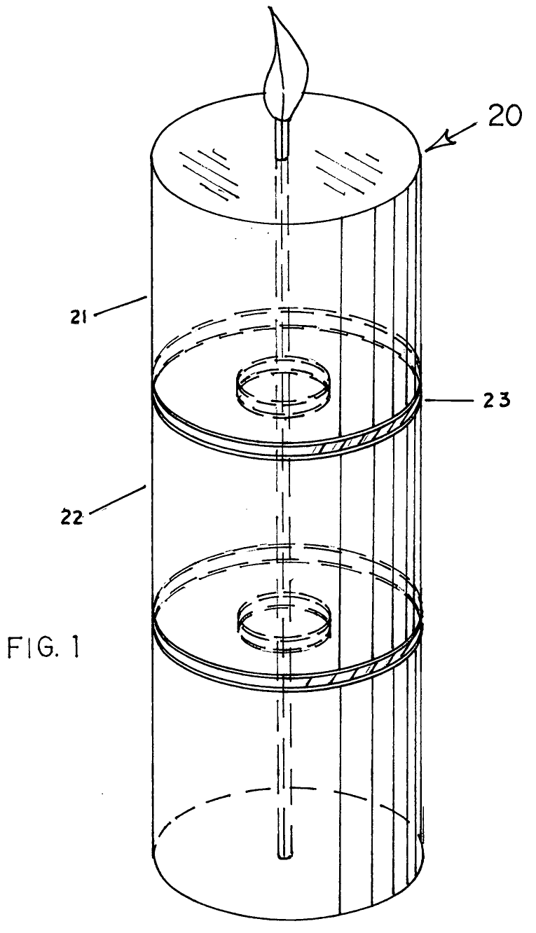

FIG. 1 is a perspective view of the assembled candle with the spacers there between.

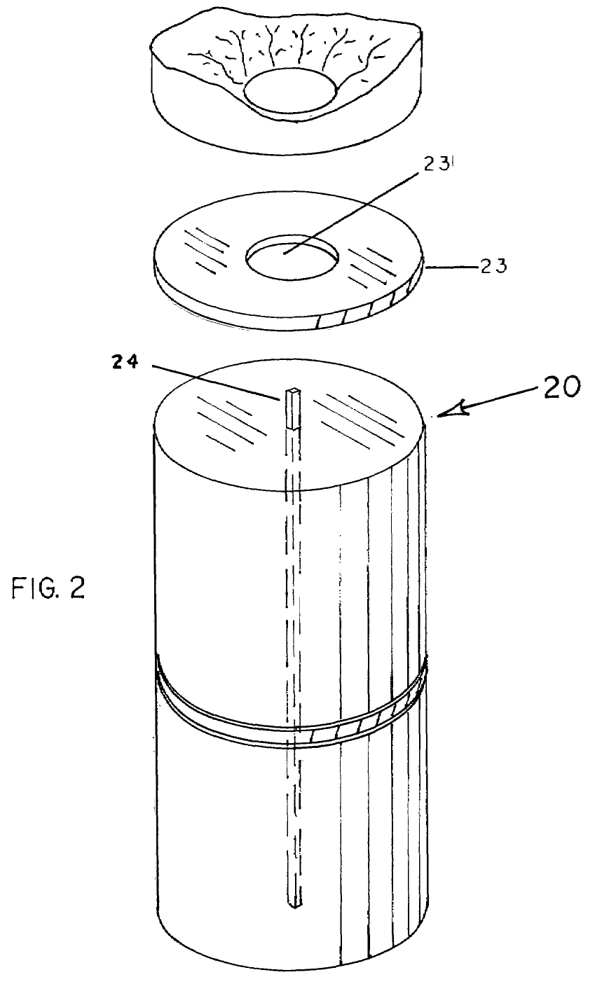

FIG. 2 is a perspective view of the spacer candle after the removing the partially unburned and recessed candle portion and the spacer and re-igniting the remaining candle.

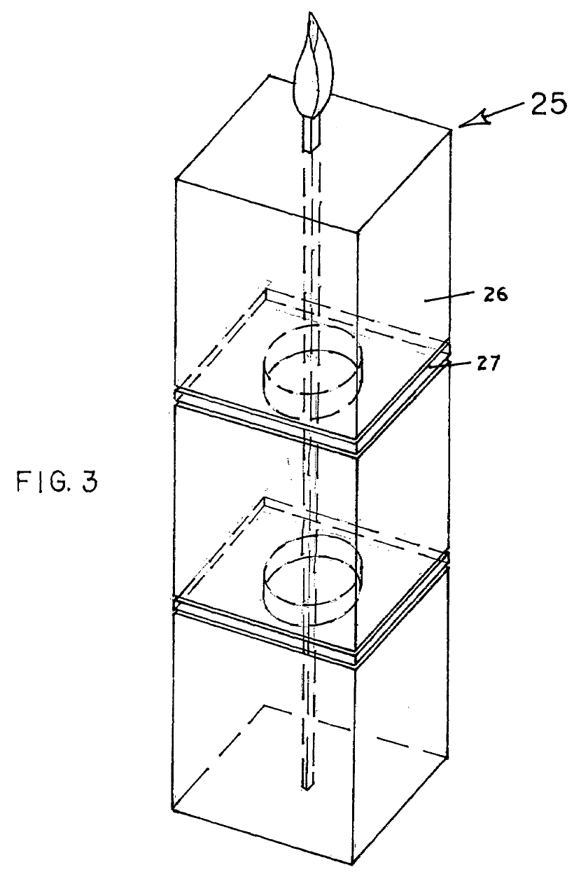

FIG. 3 is a perspective view of the first alternate form of the assembled candle with the spacers there in between.

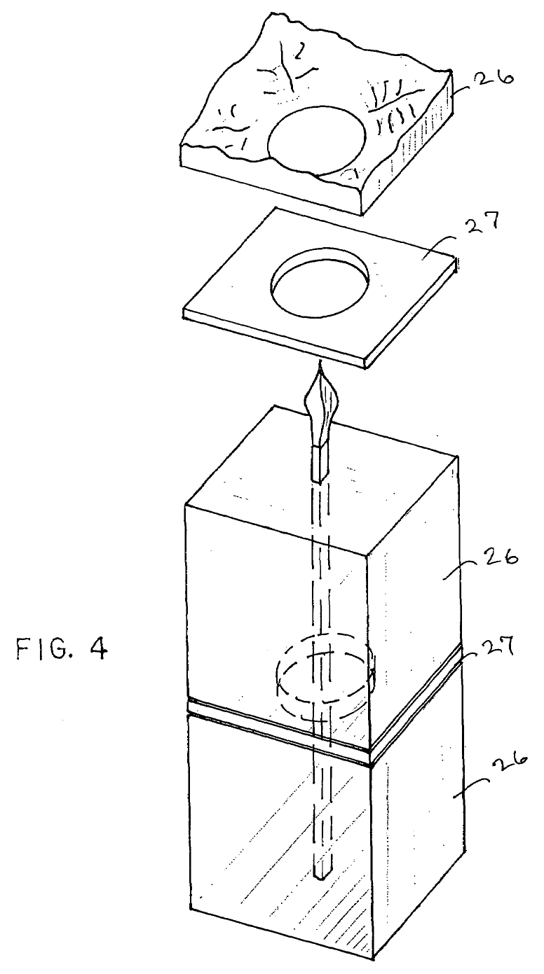

FIG. 4 is a perspective view the first alternate form of the spacer candle after the removing the partially unburned and recessed candle portion and the spacer and re-igniting the remaining candle.

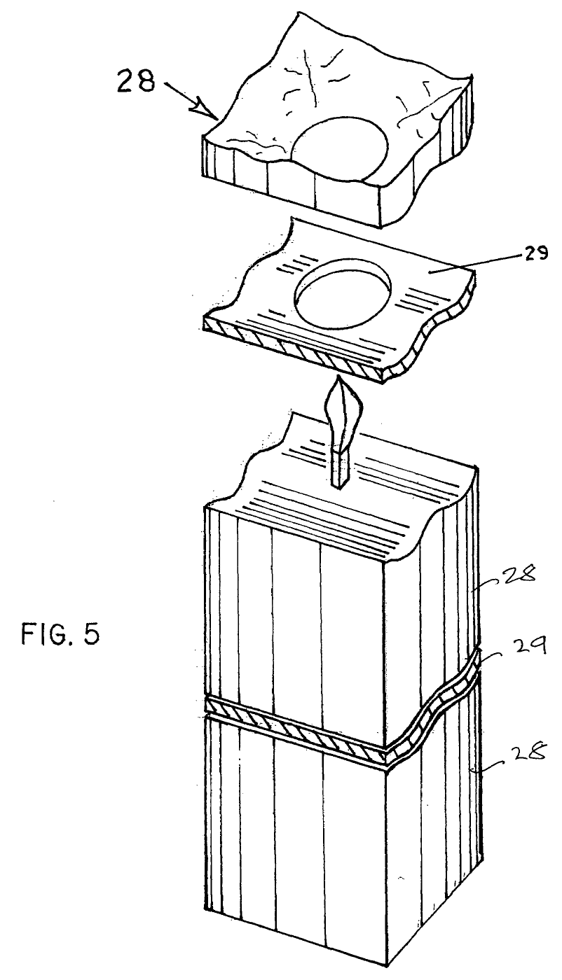

FIG. 5 is a perspective view of the second alternate form of the spacer candle after the removing the partially unburned and recessed candle portion and the spacer and re-igniting the remaining candle.

Referring more particularly to the drawings, in FIG. 1 the spacer candle invention 20 is illustrated assembled with wax sections 21 and 22 with a plate like spacer 23 fitted between the wax sections 21 and 22.

The non-wax non-flammable material such as flat plate-like spacers may be provided in the candle so that the candle may be easily separated into sections. In separating the candle into sections, provision may be made to enable the wick to be cut by some means. A separate wick may be provided for each section, or it may be constructed as one single continuous wicks as several wicks stacked together in various forms.

The advantage to forming the candles into several sections, among other things, before the candle burns fully to the spacer, the remaining, unburned portion of the candle, in normal circumstances will burn to a hollow recessed portion. This leaves an ugly, unsightly appearance to the candle and undesirably obstructs the light radiating outwardly from the candle flame. By providing for a spacer, this hollow recessed portion may be broken off cleanly at the spacer, so that the top of the candle will have an even like-new surface rather than a hollowed out surface just as though it was a new candle.

The spacer can be in a flat plate shape with removed center portion 23 and can be molded into the overall candle. The spacer 23 can be in a flat or waved plate shape with removed center portion 23′ which has an overall surface area less than that of the adjacent sections of the candle so that portions of the wax between adjoining sections will adhere together after molding to hold the candle together with the spacer contained within. The spacer preferably has the center area 23′ cut out so that a single wick 24 may be used. Further the wax of one section surrounding the wick may adhere to the wax of the next section surrounding the wick through the center area 23′. The adhering wax sections provide structure for the candle through the center area until the candle is burned down and the wick is near the spacer. At which time, the upper section may be turned free from the next section and the spacer has been removed and the remaining wick projecting from the unburned section remains contiguous therein.

As a first alternate form of the invention of the spacer candle invention 25, the candle may be made in a non round shape such a square or rectangular such as shown in FIGS. 3 and 4 and designated by the numeral 25 wherein the candle portion 26 is square and the spacer plate 27 is square. This is being done as an artistic variation of original form of the invention.

As a second alternate form of the invention of the spacer candle invention 28, has spacer plates 29 constructed in a waved or non-flat configuration. This is being done as an artistic variation of original form of the invention.

It will be obvious that various changes and departures may be made to the invention without departing from the spirit and scope thereof and accordingly it is not intended that the invention be limited to that specifically described in the specification or as illustrated in the drawings but only as set forth in the appended claims wherein:

What is claimed is:

1. A candle formed of wax sections separated by relatively thin non flammable flat plates, said plates having a central cutout to allow for wick means for each section, said candle being burnable by igniting the wick of the upper most wax section, allowing the wick and wax of that section to burn for illumination until it reaches the plate of the next wax section, and should the operator terminate illumination prior to reaching the entire burning to the next separating plate, the operator may break off the unburned portion of the burning section and remove the plate to provide a like-new upper surface to the next section of the candle and subsequently resume the illumination operation by igniting the newly exposed wick means of the immediately lower unburned section of the candle.

2. An upwardly extending elongated candle comprising a plurality of wax sections separated by relatively thin non-flammable plates, said plates having the center portion removed to allow a common wick means to extend centrally along and through the wax section and plates, said removed center portion of the plates allowing for the filling of wax when molding between adjacent wax sections to provide supporting and adhering means to adjacent wax sections, said elongated candle being ignitable at its top end of the common wick means at the uppermost wax section, allowing the wick and wax of that section to burn downwardly along the length of the uppermost candle section for illumination until it has been burned to at least generally the level of the plate separating the candle sections, whereby, if the operator wishes to terminate the illumination operation, the operator may break off any unburned portion of the uppermost wax section along the separating plate, remove the plate, exposing the next uppermost wax section there beneath, thereby providing a like-new relatively flat upper surface to the next section of the candle.

3. A candle comprising a plurality of wax sections with separating non-flammable spacers, said spacers having a cross-sectional shape generally matching that of the adjacent upper and lower wax portions of the candle, said spacers having an overall surface area less than that of the adjacent sections of the candle so that portions of the wax of adjoining sections will adhere together after molding to hold the candle together with the spacer contained within, said spacers separating said candle between said wax sections, a wick means extending centrally along and through the wax sections and the spacers, said candle being ignitable at its top end of the wick means at the uppermost wax section, allowing the wick means and wax of that section to burn downwardly along the length of the uppermost candle section for illumination until it has been burned to at least generally the level of the disc separating the candle sections, whereby if the operator wishes to terminate the illumination operation the operator may break off any unburned portion of the uppermost wax section along the wax portion connecting that section to the next adjacent wax section there beneath, and remove the spacer to provide a new relatively flat upper surface to the next section of the candle.
